(19) United States
(12) Patent Application Publication
(10) Pub. No.: US 2018/0364437 A1
(43) Pub. Date: Dec. 20, 2018

(54) OPTICAL FIBER AND OPTICAL FIBER RIBBON

(71) Applicant: SUMITOMO ELECTRIC INDUSTRIES, LTD., Osaka (JP)

(72) Inventors: Kumiko TACHIBANA, Osaka (JP); Masaji OOKIDO, Osaka (JP); Takashi FUJII, Osaka (JP)

(73) Assignee: SUMITOMO ELECTRIC INDUSTRIES, LTD., Osaka (JP)

(21) Appl. No.: 16/008,498

(22) Filed: Jun. 14, 2018

(30) Foreign Application Priority Data
Jun. 20, 2017 (JP) 2017-120516

(51) Int. Cl. G02B 6/44; G02B 6/02

(52) U.S. Cl. CPC G02B 6/4494; G02B 6/02395; G02B 6/4415; G02B 6/4403

(57) ABSTRACT

An optical fiber comprises a glass fiber; and a coating resin layer coating an outer periphery of the glass fiber, the coating resin layer comprises a cured product of an ultraviolet curable resin composition containing a urethane oligomer, a monomer, and a photopolymerization initiator, and the urethane oligomer contains a one-end non-reactive oligomer having a (meth)acryloyl group at one end and having an alkoxy group having 3 to 18 carbon atoms at the other end.

### TECHNICAL FIELD

The present invention relates to an optical fiber and an optical fiber ribbon.

This application claims priority from Japanese Patent Application No. 2017-120516 filed on Jun. 20, 2017, the entire contents of which are incorporated herein.

### BACKGROUND

An optical fiber generally has a coating resin layer for protecting a glass fiber that is an optical transmission medium. For example, in WO 2016/059727 A1, an optical fiber having a coating resin layer is disclosed.

### SUMMARY

In the case of conventional optical fibers, the transmission loss may increase when they are immersed in water for a long period, and the improvement of water resistance is required of optical fibers.

Accordingly, it is an object of the present invention to provide an optical fiber and an optical fiber ribbon having excellent water resistance.

An optical fiber according to one aspect of the present invention comprises a glass fiber; and a coating resin layer coating an outer periphery of the glass fiber, the coating resin layer comprises a cured product of an ultraviolet curable resin composition containing a urethane oligomer, a monomer, and a photopolymerization initiator, and the urethane oligomer contains a one-end non-reactive oligomer having a (meth)acryloyl group at one end and having an alkoxy group having 3 to 18 carbon atoms at the other end.

According to the present invention, it is possible to provide an optical fiber and an optical fiber ribbon having excellent water resistance.

### BRIEF DESCRIPTION OF THE DRAWINGS

FIG. 1 is a schematic cross-sectional view showing one example of the optical fiber of the present invention; and FIG. 2 is a schematic cross-sectional view showing one example of the optical fiber ribbon of the present invention.

### DETAILED DESCRIPTION

### Description of Embodiments of the Present Invention

First, the contents of embodiments of the present invention will be listed and described. An optical fiber according to one aspect of the present invention comprises a glass fiber; and a coating resin layer coating the outer periphery of the glass fiber, the coating resin layer comprises a cured product of an ultraviolet curable resin composition containing a urethane oligomer, a monomer, and a photopolymerization initiator, and the urethane oligomer contains a one-end non-reactive oligomer having a (meth)acryloyl group at one end and having an alkoxy group having 3 to 18 carbon atoms at the other end.

The optical fiber in this embodiment comprises the above particular coating resin layer, and thus the optical fiber is excellent in water resistance, and an increase in transmission loss can be suppressed even if the optical fiber is immersed in water for a long period.

The above one-end non-reactive oligomer may be the reaction product of a polyol, a polyisocyanate, a hydroxyl group-containing (meth)acrylate, and a monohydric alcohol having 3 to 18 carbon atoms. Thus, a coating resin layer excellent in water resistance can be formed.

The above coating resin layer may comprise a primary resin layer and a secondary resin layer, and the primary resin layer may contain the cured product of the above resin composition. Thus, the water resistance of the optical fiber can be further improved.

From the viewpoint of improving the microbending resistance characteristics of the optical fiber, the Young's modulus of the above primary resin layer may be 0.7 MPa or less at 23° C.

In an optical fiber ribbon according to one embodiment of the present invention, a plurality of the above optical fibers are arranged in a row and coupled by a ribbon material. Since the optical fibers in this embodiment are used, an increase in transmission loss can be suppressed even when the optical fiber ribbon is immersed in water for a long period.

### Details of Embodiments of the Present Invention

Specific examples of an optical fiber and an optical fiber ribbon according to embodiments of the present invention will be described below with reference to the drawings. It is intended that the present invention is not limited to these illustrations, is shown by the claims, and includes all changes within the meaning and scope equivalent to the claims. In the following description, like numerals refer to like elements in the description of the drawings, and redundant description is omitted.

(Optical Fiber)

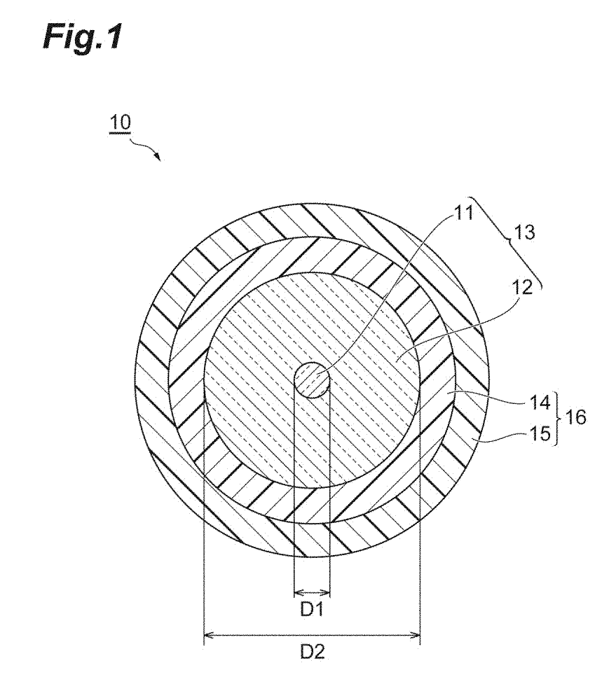

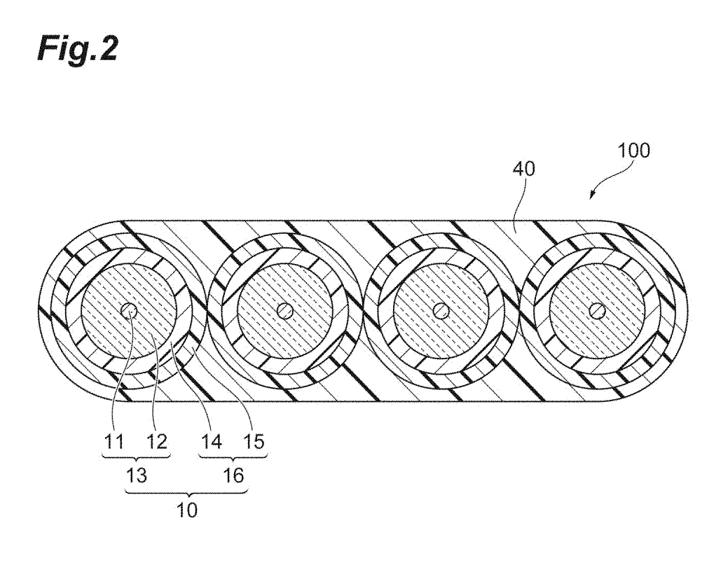

FIG. 1 is a schematic cross-sectional view showing one example of an optical fiber that is one mode of the present invention. An optical fiber 10 comprises a glass fiber 13 and a coating resin layer 16 provided on the outer periphery of the glass fiber 13.

The glass fiber 13 consists of a core 11 and a cladding 12, and the cladding 12 surrounds the core 11. The core 11 and the cladding 12 mainly comprise glass such as quartz glass, and, for example, quartz to which germanium is added can be used for the core 11, and pure quartz or quartz to which fluorine is added can be used for the cladding 12.

In FIG. 1, for example, the outer diameter (D2) of the glass fiber 13 is about 125 μm, and the diameter (D1) of the core 11 constituting the glass fiber 13 is about 7 to 15 μm.

The coating resin layer 16 may be composed of only one layer or may be composed of a plurality of layers. The coating resin layer 16 may comprise a primary resin layer 14 provided in contact with the outer periphery of the glass fiber 13, and a secondary resin layer 15 coating the primary resin layer 14.

The thickness of the coating resin layer 16 is usually about 60 to 70 μm. The thickness of each of the primary resin layer 14 and the secondary resin layer 15 may be about 10 to 50 μm, and, for example, the thickness of the primary resin layer 14 may be 35 μm, and the thickness of the secondary resin layer 15 may be 25 μm. The outer diameter of the optical fiber 10 may be about 245 to 265 μm.

The coating resin layer 16 can be formed, for example, by curing an ultraviolet curable resin composition (hereinafter also simply referred to as a “resin composition”) comprising a urethane oligomer, a monomer, and a photopolymerization initiator.

The urethane oligomer can be prepared by reacting a polyol, a polyisocyanate, a hydroxyl group-containing (meth)acrylate, and a monohydric alcohol having 3 to 18 carbon atoms.

Here, a (meth)acrylate means an acrylate or the methacrylate corresponding to the acrylate. The same applies to a (meth)acryloyl.

Examples of the polyol include polytetramethylene glycol, polypropylene glycol, and bisphenol A-ethylene oxide-added diol.

Examples of the polyisocyanate include 2,4-tolylene diisocyanate, 2,6-tolylene diisocyanate, isophorone diisocyanate, and dicyclohexylmethane 4,4′-diisocyanate.

Examples of the hydroxyl group-containing (meth)acrylate include 2-hydroxyethyl (meth)acrylate, 2-hydroxybutyl (meth)acrylate, 1,6-hexanediol mono(meth)acrylate, pentaerythritol tri(meth)acrylate, 2-hydroxypropyl (meth)acrylate, and tripropylene glycol di(meth)acrylate.

Examples of the monohydric alcohol having 3 to 18 carbon atoms include 1-propanol, 2-propanol, 1-butanol, 2-butanol, 2-methyl-2-propanol, 1-pentanol, 2-pentanol, 3-pentanol, 2-methyl-1-butanol, 3-methyl-1-butanol, 2-methyl-2-butanol, 3-methyl-2-butanol, 2,2-dimethyl-1-propanol, capryl alcohol, lauryl alcohol, myristyl alcohol, cetyl alcohol, stearyl alcohol, and oleyl alcohol. Among them, alcohols that are monohydric alcohols having 4 to 18 carbon atoms and linear are preferred.

When the urethane oligomer is prepared, a catalyst, a polymerization inhibitor, and the like may be used. Examples of the catalyst include dibutyltin dilaurate, dibutyltin diacetate, dibutyltin maleate, dibutyltin bis(2-ethylhexyl mercaptoacetate), dibutyltin bis(isooctyl mercaptoacetate), and dibutyltin oxide. Examples of the polymerization inhibitor include methoquinone and hydroquinone.

The preparation of the urethane oligomer will be described below by giving a specific example. For example, when polypropylene glycol, tolylene diisocyanate, 2-hydroxyethyl acrylate, and butanol are used as the polyol, the polyisocyanate, the hydroxyl group-containing (meth)acrylate, and the monohydric alcohol, respectively, the urethane oligomer can comprise the following reaction products (A) and (B):

H-TDI-(PPG-TDI)n-R (A):

H-TDI-(PPG-TDI)n-H (B):

wherein H represents the residue of 2-hydroxyethyl acrylate, TDI represents the residue of tolylene diisocyanate, PPG represents the residue of polypropylene glycol, and R represents the residue of butanol. n represents an integer of 1 or more and is preferably 1 to 4.

The reaction product (A) is a one-end non-reactive oligomer and therefore has the effect of decreasing the crosslinking density of the cured product and can reduce Youngs modulus. In addition, the reaction product (A) has a hydrophobic alkoxy group as the butanol residue at one end and therefore can improve the water resistance of the cured product. The reaction product (B) is a both-ends reactive oligomer and therefore can increase the crosslinking density of the cured product.

The urethane oligomer according to this embodiment contains a one-end non-reactive oligomer having a (meth)acryloyl group at one end and having an alkoxy group having 3 to 18 carbon atoms at the other end. The one-end non-reactive oligomer is the reaction product of a polyol, a polyisocyanate, a hydroxyl group-containing (meth)acrylate, and a monohydric alcohol having 3 to 18 carbon atoms. It is considered that an alkoxy group having 3 or more carbon atoms has higher hydrophobicity than a methoxy group and an ethoxy group and therefore can improve the water resistance of the coating resin layer. From the viewpoint of further improving the water resistance of the coating resin layer, the one-end non-reactive oligomer preferably has an alkoxy group having 4 to 18 carbon atoms.

From the viewpoint of further improving the water resistance of the coating resin layer, the urethane oligomer preferably comprises 20% by mass or more, more preferably 30 to 100% by mass, and further preferably 40 to 100% by mass of the one-end non-reactive oligomer based on the total amount of the urethane oligomer.

The urethane oligomer may further contain a both-ends reactive oligomer having (meth)acryloyl groups at both ends. The both-ends reactive oligomer is the reaction product of a polyol, a polyisocyanate, and a hydroxyl group-containing (meth)acrylate.

The content of the urethane oligomer in the resin composition is preferably 35 to 90% by mass, more preferably 50 to 85% by mass, and further preferably 60 to 80% by mass based on the total amount of the resin composition.

As the monomer, a monofunctional monomer having one polymerizable group, and a polyfunctional monomer having two or more polymerizable groups can be used. Two or more monomers may be mixed and used.

Examples of the monofunctional monomer include (meth)acrylate-based monomers such as methyl (meth)acrylate, ethyl (meth)acrylate, propyl (meth)acrylate, n-butyl (meth)acrylate, sec-butyl (meth)acrylate, tert-butyl (meth)acrylate, isobutyl (meth)acrylate, n-pentyl (meth)acrylate, isopentyl (meth)acrylate, hexyl (meth)acrylate, heptyl (meth)acrylate, isoamyl (meth)acrylate, 2-ethylhexyl (meth)acrylate, n-octyl (meth)acrylate, isooctyl (meth)acrylate, isodecyl (meth)acrylate, lauryl (meth)acrylate, phenoxyethyl (meth)acrylate, tetrahydrofurfuryl (meth)acrylate, benzyl (meth)acrylate, dicyclopentenyl (meth)acrylate, dicyclopentenyloxyethyl (meth)acrylate, dicyclopentenyl (meth)acrylate, nonylphenol polyethylene glycol (meth)acrylate, nonylphenoxypolyethylene glycol (meth)acrylate, and isobornyl (meth)acrylate; carboxyl group-containing monomers such as (meth)acrylic acid, a (meth)acrylic acid dimer, carboxyethyl (meth)acrylate, carboxypentyl (meth)acrylate, and ω-carboxy-polycaprolactone (meth)acrylate; heterocycle-containing monomers such as N-acryloylmorpholine, N-vinylpyrrolidone, N-vinylcaprolactam, N-acryloylpiperidine, N-methacryloylpiperidine, 3-(3-pyridinyl)propyl (meth)acrylate, and N-acryloylpyrrolidine; maleimide-based monomers such as maleimide, N-cyclohexylmaleimide, and N-phenylmaleimide; N-substituted amide-based monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-butyl(meth)acrylamide, N-methylol(meth)acrylamide, and N-methylolpropane(meth)acrylamide; and aminoalkyl (meth)acrylate-based monomers such as aminoethyl (meth)acrylate, aminopropyl (meth)acrylate, N,N-dimethylaminoethyl (meth)acrylate, and tert-butylaminoethyl (meth)acrylate. Among them, the monomer preferably comprises a heterocycle-containing monomer because of excellent rapid curability.

Examples of the polyfunctional monomer include bifunctional monomers such as ethylene glycol di(meth)acrylate, polyethylene glycol di(meth)acrylate, polypropylene glycol di(meth)acrylate, neopentyl glycol di(meth)acrylate, tripropylene glycol di(meth)acrylate, the di(meth)acrylate of a bisphenol A diglycidyl ether acrylic acid adduct, tetraethylene glycol di(meth)acrylate, hydroxypivalic acid neopentyl glycol di(meth)acrylate, 1,4-butanediol di(meth)acrylate, 1,6-hexanediol di(meth)acrylate, 1,9-nonanediol di(meth)acrylate, 1,12-dodecanediol di(meth)acrylate, 1,14-tetradecanediol di(meth)acrylate, 1,16-hexadecanediol di(meth)acrylate, 1,20-eicosanediol di(meth)acrylate, isopentyldiol di(meth)acrylate, 3-ethyl-1,8-octanediol di(meth)acrylate, and the ethylene oxide adduct di(meth)acrylate of bisphenol A; and tri- or higher functional monomers such as trimethylolpropane tri(meth)acrylate, trimethyloloctane tri(meth)acrylate, trimethylolpropane polyethoxy tri(meth)acrylate, trimethylolpropane polypropoxy tri(meth)acrylate, trimethylolpropane polyethoxy polypropoxy tri(meth)acrylate, tris[(meth)acryloyloxyethyl] isocyanurate, pentaerythritol tri(meth)acrylate, pentaerythritol polyethoxy tetra(meth)acrylate, pentaerythritol polypropoxy tetra(meth)acrylate, pentaerythritol tetra(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, and caprolactone-modified tris[(meth)acryloyloxyethyl] isocyanurate. Among them, the monomer preferably comprises a bifunctional monomer in order to improve the toughness of the primary resin layer.

The content of the monomer in the resin composition is preferably 5 to 45% by mass, more preferably 10 to 40% by mass, and further preferably 15 to 30% by mass based on the total amount of the resin composition.

The photopolymerization initiator can be appropriately selected from among known radical photopolymerization initiators and used, and examples of the photopolymerization initiator include acylphosphine oxide-based initiators and acetophenone-based initiators. Two or more photopolymerization initiators may be mixed and used.

Examples of the acetophenone-based initiators include 1-hydroxycyclohexyl phenyl ketone (manufactured by BASF SE, trade name “Irgacure 184”), 2-hydroxy-2-methyl-1-phenyl-propan-1-one (manufactured by BASF SE, trade name “Irgacure 1173”), 2,2-dimethoxy-1,2-diphenylethan-1-one (manufactured by BASF SE, trade name “Irgacure 651”), 2-methyl-1-(4-methylthiophenyl)-2-morpholinopropan-1-one (manufactured by BASF SE, trade name “Irgacure 907”), 2-benzyl-2-dimethylamino-1-(4-morpholinophenyl)-butanone-1 (manufactured by BASF SE, trade name “Irgacure 369”), 1-hydroxycyclohexyl phenyl ketone, 2,2-dimethoxy-2-phenylacetophenone, and 1-(4-isopropylphenyl)-2-hydroxy-2-methylpropan-1-one.

Examples of the acylphosphine oxide-based initiators include 2,4,6-trimethylbenzoyldiphenylphosphine oxide (manufactured by BASF SE, trade name “Irgacure TPO”), bis(2,4,6-trimethylbenzoyl)phenylphosphine oxide (manufactured by BASF SE, trade name “Irgacure 819”), bis(2,6-dimethoxybenzoyl)2,4,4-trimethylpentylphosphine oxide, and 2,4,6-trimethylbenzoyldiphenylphosphine oxide.

The content of the photopolymerization initiator in the resin composition is preferably 0.1 to 10% by mass, more preferably 0.3 to 7% by mass, and further preferably 0.5 to 5% by mass based on the total amount of the resin composition.

A silane coupling agent may be blended into the resin composition according to this embodiment. Particularly when the resin composition forming the primary resin layer contains a silane coupling agent, the adhesive force between the glass fiber and the primary resin layer is easily adjusted. The silane coupling agent is not particularly limited as long as it does not hinder the curing of the resin composition. Two or more silane coupling agents may be mixed and used.

As the silane coupling agent, a silane coupling agent represented by formula (1) or (2) may be used.

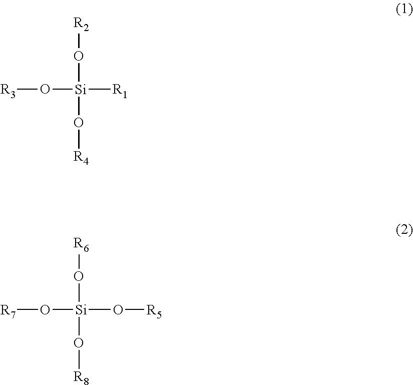

In formula (1), R₁ represents a group having reactivity to ultraviolet irradiation. Examples of the group having reactivity to ultraviolet irradiation include groups having functional groups such as a mercapto group, a mercaptoalkyl group, a vinyl group, an allyl group, and a (meth)acryloyl group.

In formulas (1) and (2), R₂ to R₈ each independently represent an alkyl group having 1 to 4 carbon atoms. Examples of R₂ to R₈ include methyl groups, ethyl groups, propyl groups, and butyl groups. R₂ to R₄ in formula (1) may each be the same or different, and R₅ to R₈ in formula (2) may each be the same or different.

Examples of the silane coupling agent represented by formula (1) include 3-mercaptopropyltrimethoxysilane, 3-mercaptopropyltriethoxysilane, 3-mercaptopropyltripropoxysilane, allyltrimethoxysilane, allyltriethoxysilane, allyltripropoxysilane, vinyltrimethoxysilane, vinyltriethoxysilane, vinyltripropoxysilane, 3-(meth)acryloxypropyltrimethoxysilane, and 3-(meth)acryloxypropyltriethoxysilane.

Examples of the silane coupling agent represented by formula (2) include tetramethoxysilane, tetraethoxysilane, and tetrapropoxysilane.

The content of the silane coupling agent in the resin composition is preferably 0.2 to 5% by mass, more preferably 0.3 to 3% by mass, and further preferably 0.5 to 2% by mass based on the total amount of the resin composition.

The resin composition according to this embodiment may further comprise a photo-acid generating agent, a leveling agent, an antifoaming agent, an antioxidant, a photosensitizer, and the like.

From the viewpoint of further improving the water resistance of the optical fiber, the resin composition according to this embodiment is preferably applied to the primary resin layer 14.

The Young's modulus of the primary resin layer 14 is preferably 0.8 MPa or less at 23° C., and is preferably 0.7 MPa or less, further preferably 0.5 MPa or less, from the viewpoint of improving macrobending resistance characteristics. The Young's modulus of the primary resin layer 14 is preferably 0.03 MPa or more at 23° C., and is more preferably 0.04 MPa or more, further preferably 0.05 MPa or more, from the viewpoint of suppressing an increase in transmission loss at low temperature. The Young's modulus of the primary resin layer 14 can be measured by the Pullout Modulus test of the optical fiber 10 at 23° C. The Young's modulus of the primary resin layer 14 can be adjusted by the content of the one-end non-reactive oligomer, the curing conditions of the resin composition, and the like.

The resin composition for the secondary resin layer is not particularly limited and may be prepared by appropriately selecting from the urethane oligomers, the monomers, and the photopolymerization initiators described above. However, the resin composition for the secondary resin layer has a composition different from that of the resin composition for the primary resin layer.

As the method for forming the coating resin layer 16 on the glass fiber 13, methods conventionally used for the manufacture of optical fibers can be applied.

The optical fiber 10 in this embodiment can be manufactured by applying the resin composition to the outer periphery of the glass fiber 13 and then irradiating the applied resin composition with ultraviolet rays to cure the resin composition to form the coating resin layer 16. At this time, a method (wet-on-dry method) may be used in which the resin composition for the primary resin layer is applied to the outer periphery of the glass fiber 13 and cured by irradiation with ultraviolet rays to form the primary resin layer 14, and then the resin composition for the secondary resin layer is applied to the periphery of the primary resin layer 14 and cured by irradiation with ultraviolet rays to form the secondary resin layer 15. A method (wet-on-wet method) may be used in which the resin composition for the primary resin layer is applied to the outer periphery of the glass fiber 13, then the resin composition for the secondary resin layer is applied to the periphery thereof, and they are simultaneously cured by irradiation with ultraviolet rays to form the primary resin layer 14 and the secondary resin layer 15.

A colored layer that is an ink layer may be formed on the outer peripheral surface of the secondary resin layer 15 constituting the coating resin layer 16 in order to distinguish the optical fiber. The secondary resin layer 15 may be a colored layer. The colored layer preferably contains a pigment from the viewpoint of improving the distinguishability of the optical fiber. Examples of the pigment include coloring pigments such as carbon black, titanium oxide, and flowers of zinc, magnetic powders such as γ-Fe₂O₃, mixed crystals of γ-Fe₂O₃ and γ-Fe₃O₄, CrO₂, cobalt ferrite, cobalt-adhered iron oxide, barium ferrite, Fe—Co, and Fe—Co—Ni, and inorganic pigments such as MIO, zinc chromate, strontium chromate, aluminum tripolyphosphate, zinc, alumina, glass, and mica. Organic pigments such as azo pigments, phthalocyanine-based pigments, and dyeing lake pigments can also be used. The pigment may be subjected to treatment such as various surface modifications and composite pigment formation.

[Optical Fiber Ribbon]

An optical fiber ribbon can be fabricated using the optical fibers in this embodiment. FIG. 2 is a schematic cross-sectional view showing one example of an optical fiber ribbon 100 in this embodiment. In the optical fiber ribbon 100 shown in the same figure, a plurality of (here four) optical fibers 10 arranged in a row are integrated by a ribbon material 40.

The ribbon material 40 may be formed of a thermosetting resin such as a silicone resin, an epoxy resin, or a urethane resin, or an ultraviolet curable resin such as an epoxy acrylate resin, a urethane acrylate resin, or a polyester acrylate resin, from the viewpoint of the prevention of damage to the optical fibers 10, the ease of dividing the optical fibers 10, and the like. Among them, an ultraviolet curable resin is preferred, and a urethane acrylate resin is more preferred.

### EXAMPLES

The present invention will be described in more detail below by showing the results of evaluation tests using Examples according to the present invention and a Comparative Example. The present invention is not limited to these Examples.

[Preparation of Urethane Oligomers]

### Synthesis Example 1

A reaction was performed using polypropylene glycol (NOF CORPORATION, product name “UNIOL D-2000,” number average molecular weight of 2000) as a polyol, 2,4-tolylene diisocyanate as a polyisocyanate, 2-hydroxyethyl acrylate as a hydroxyl group-containing (meth)acrylate compound, 1-propanol as a monohydric alcohol, methoquinone as a polymerization inhibitor, and dibutyltin dilaurate as a catalyst, to prepare an oligomer shown in Table 1.

### Synthesis Example 2

An oligomer shown in Table 1 was prepared in the same manner as in Synthesis Example 1 except that 1-butanol was used as the monohydric alcohol.

### Synthesis Example 3

An oligomer shown in Table 1 was prepared in the same manner as in Synthesis Example 1 except that lauryl alcohol was used as the monohydric alcohol.

### Synthesis Example 4

An oligomer shown in Table 1 was prepared in the same manner as in Synthesis Example 1 except that stearyl alcohol was used as the monohydric alcohol.

### Synthesis Example 5

An oligomer shown in Table 1 was prepared in the same manner as in Synthesis Example 2 except that the amounts of 2-hydroxyethyl acrylate and 1-butanol blended were changed.

### Synthesis Example 6

An oligomer shown in Table 1 was prepared in the same manner as in Synthesis Example 2 except that the amounts of 2-hydroxyethyl acrylate and 1-butanol blended were changed.

### Comparative Synthesis Example 1

An oligomer shown in Table 1 was prepared in the same manner as in Synthesis Example 1 except that methanol was used as the monohydric alcohol.

TABLE 1

| | | | | | | | Comparative |
|---|---|---|---|---|---|---|---|
| | Synthesis | Synthesis | Synthesis | Synthesis | Synthesis | Synthesis | Synthesis |
| | Example 1 | Example 2 | Example 3 | Example 4 | Example 5 | Example 6 | Example 1 |
| Number of carbon atoms of | 3 | 4 | 12 | 18 | 4 | 4 | 1 |
| monohydric alcohol | | | | | | | |
| One-end non-reactive | 40 | 40 | 40 | 40 | 100 | 20 | 40 |
| oligomer (% by mass) | | | | | | | |

### Example 1

### (Resin Composition for Primary Resin Layer)

75 Parts by mass of the oligomer obtained in Synthesis Example 1, as a urethane oligomer, 12 parts by mass of nonylphenyl acrylate and 6 parts by mass of N-vinylcaprolactam as monofunctional monomers, 2 parts by mass of 1,6-hexanediol diacrylate as a polyfunctional monomer, 1 part by mass of 2,4,6-trimethylbenzoyldiphenylphosphine oxide (Irgacure TPO) as a photopolymerization initiator, and 1 part by mass of 3-mercaptopropyltrimethoxysilane as a silane coupling agent were mixed to prepare a resin composition.

(Resin Composition for Secondary Resin Layer)

75 Parts by mass of a urethane oligomer obtained by reacting polypropylene glycol having a number average molecular weight of 1000, 2,4-tolylene diisocyanate, and 2-hydroxyethyl acrylate, 10 parts by mass of the ethylene oxide adduct diacrylate of bisphenol A, and 3 parts by mass of 1-hydroxycyclohexyl phenyl ketone (Irgacure 184) were mixed to prepare a resin composition.

(Fabrication of Optical Fiber 10)

A glass fiber 13 composed of a core 11 and a cladding 12 and having an outer diameter (D2) of 125 μm was provided. Then, the outer peripheral surface of the glass fiber 13 was coated with the resin composition for a primary resin layer and the resin composition for a secondary resin layer and irradiated with ultraviolet rays to form a coating resin layer 16 (a primary resin layer 14 and a secondary resin layer 15) to fabricate an optical fiber 10. The thickness of the primary resin layer 14 was 35 μm, and the thickness of the secondary resin layer 15 was 25 μm.

(Evaluation of Water Resistance)

The water resistance of the optical fiber was evaluated by immersing the optical fiber in water. First, the transmission loss of light having a wavelength of 1550 nm for the optical fiber 10 was measured at 23° C. Then, the optical fiber was immersed in water at 23° C. for 120 days, and then the transmission loss of light having a wavelength of 1550 nm was measured. An increase in transmission loss of less than 0.03 dB/km was taken as “A,” an increase in transmission loss of 0.03 to 0.05 dB/km was taken as “B,” and an increase in transmission loss of more than 0.05 dB/km was taken as “C.”

### Examples 2 to 4 and Comparative Example 1

An optical fiber 10 was fabricated and the water resistance was evaluated in the same manner as in Example 1 except that a resin composition for a primary resin layer was prepared using a urethane oligomer shown in Table 2.

TABLE 2

| | | | | | Comparative |
|---|---|---|---|---|---|
| | Example 1 | Example 2 | Example 3 | Example 4 | Example 1 |
| Urethane oligomer | Synthesis | Synthesis | Synthesis | Synthesis | Comparative |
| | Example 1 | Example 2 | Example 3 | Example 4 | Synthesis |
| | | | | | Example 1 |
| Number of carbon atoms of | 3 | 4 | 12 | 18 | 1 |
| monohydric alcohol | | | | | |
| Water resistance | B | A | A | A | C |

### Examples 5 to 10

An optical fiber 10 was fabricated and the water resistance was evaluated in the same manner as in Example 1 except that a resin composition for a primary resin layer was prepared using a urethane oligomer shown in Table 3, and the velocity at which the optical fiber was drawn (linear velocity) was changed (the amount of ultraviolet rays with which the resin composition for the coating resin layer was irradiated was changed). For the fabricated optical fiber 10, the following evaluation tests were performed. The results are shown in Table 3. For the linear velocity in Table 3, “High” indicates more than 1500 m/min, “Medium” indicates 500 to 1500 m/min, and “Low” indicates less than 500 m/min.

(Young's Modulus of Primary Resin Layer)

The Young's modulus of the primary resin layer was measured by a Pullout Modulus (POM) method at 23° C. Two parts of the optical fiber 10 were fixed by two chuck apparatuses, the coating resin layer 16 (the primary resin layer 14 and the secondary resin layer 15) portion between the two chuck apparatuses was removed, then one chuck apparatus was fixed, and the other chuck apparatus was slowly moved in the direction opposite to the fixed chuck apparatus. The Young's modulus of the primary resin layer 14 (POM value) was obtained from the following formula:

Young's modulus (MPa)=((1+n)W/πLZ)×ln(Dp/Df)

wherein L represents the length of the portion of the optical fiber 10 pinched by the chuck apparatus to be moved, Z represents the amount of movement of the chuck, Dp represents the outer diameter of the primary resin layer 14, Df represents the outer diameter of the glass fiber 13, n represents the Poisson's ratio of the primary resin layer 14, and W represents the load during the movement of the chuck apparatus.

(Microbending Characteristics)

The microbending resistance characteristics of the optical fiber were evaluated by a lateral pressure test. The transmission loss of light having a wavelength of 1550 nm when the optical fiber 10 was wound in the form of a single layer around a bobbin having a diameter of 280 mm whose surface was covered with sandpaper was measured by an OTDR (Optical Time Domain Reflectometer) method. The transmission loss of light having a wavelength of 1550 nm when the optical fiber 10 was wound in the form of a single layer around a bobbin having a diameter of 280 mm without sandpaper was measured by the OTDR method. The difference between the measured transmission losses was obtained, and a transmission loss difference of 0.3 dB/km or less was taken as “A,” a transmission loss difference of more than 0.3 dB/km and 0.6 dB/km or less was taken as “B,” and a transmission loss difference of more than 0.6 dB/km was taken as “C.”

(Low Temperature Loss Increase)

The transmission loss of the optical fiber 10 to which a screening tension of 2 kg was applied was measured at 23° C., then the optical fiber 10 was placed at −40° C. for 2 hours, and the transmission loss was measured. The increase in the transmission loss of light having a wavelength of 1550 nm for the optical fiber 10 after the placement at −40° C. compared with that for the optical fiber 10 before the placement at −40° C. was obtained. An increase in transmission loss of more than 0.03 dB/km was taken as “B,” and an increase in transmission loss of 0.03 dB/km or less was taken as “A.”

TABLE 3

| | Example 5 | Example 6 | Example 7 | Example 8 | Example 9 | Example 10 |
|---|---|---|---|---|---|---|
| Urethane oligomer | Synthesis | Synthesis | Synthesis | Synthesis | Synthesis | Synthesis |
| | Example 5 | Example 5 | Example 5 | Example 2 | Example 2 | Example 6 |
| One-end non-reactive oligomer | 100 | 100 | 100 | 40 | 40 | 20 |
| (% by mass) | | | | | | |
| Linear velocity | High | Medium | Low | High | Medium | Low |
| Young's modulus of primary | 0.03 | 0.05 | 0.1 | 0.3 | 0.5 | 0.8 |
| resin layer (MPa) | | | | | | |
| Water resistance | A | A | A | A | A | A |
| Microbending characteristics | A | A | A | A | A | B |
| Low temperature loss increase | B | A | A | A | A | A |

What is claimed is:

1. An optical fiber comprising:
a glass fiber; and
a coating resin layer coating an outer periphery of the glass fiber, wherein
the coating resin layer comprises a cured product of an ultraviolet curable resin composition containing a urethane oligomer, a monomer, and a photopolymerization initiator, and
the urethane oligomer contains a one-end non-reactive oligomer having a (meth)acryloyl group at one end and having an alkoxy group having 3 to 18 carbon atoms at the other end.

2. The optical fiber according to claim 1, wherein the one-end non-reactive oligomer is a reaction product of a polyol, a polyisocyanate, a hydroxyl group-containing (meth)acrylate, and a monohydric alcohol having 3 to 18 carbon atoms.

3. The optical fiber according to claim 1, wherein the urethane oligomer comprises 20% by mass or more of the one-end non-reactive oligomer based on a total amount of the urethane oligomer.

4. The optical fiber according to claim 1, wherein the coating resin layer comprises a primary resin layer and a secondary resin layer, and
the primary resin layer contains the cured product of the resin composition.

5. The optical fiber according to claim 4, wherein a Young's modulus of the primary resin layer is 0.7 MPa or less at 23° C.

6. The optical fiber according to claim 2, wherein the coating resin layer comprises a primary resin layer and a secondary resin layer, and
the primary resin layer contains the cured product of the resin composition.

7. The optical fiber according to claim 6, wherein a Young's modulus of the primary resin layer is 0.7 MPa or less at 23° C.

8. The optical fiber according to claim 3, wherein the coating resin layer comprises a primary resin layer and a secondary resin layer, and
the primary resin layer contains the cured product of the resin composition.

9. The optical fiber according to claim 8, wherein a Young's modulus of the primary resin layer is 0.7 MPa or less at 23° C.

10. An optical fiber ribbon wherein a plurality of the optical fibers according to claim 1 are arranged in a row and coupled by a ribbon material.
